(19) United States
(12) Patent Application Publication
(10) Pub. No.: US 2006/0267319 A1
(43) Pub. Date: Nov. 30, 2006

(54) Vehicle steering wheel with gas bag module and horn contact

(75) Inventors: Ralph Frisch, Moembris (DE); Stefan Bohn, Goldbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems Gmbh

(21) Appl. No.: 11/432,094

(22) Filed: May 11, 2006

(30) Foreign Application Priority Data
May 30, 2005 (DE) 20 2005 008 374.7

(51) Int. Cl. B60R 21/203; H01H 9/00

(52) U.S. Cl. 280/731; 280/728.2; 200/61.54

(57) ABSTRACT

A vehicle steering wheel has a gas bag module (10). The gas bag module (10) includes a covering cap (20) and at least one horn contact (22). The covering cap (20) has a central section (36) and an outer rim section (38). The horn contact (22) has a contact element (46) arranged between the central section of the covering cap (36) and a stationary component of the gas bag module (10), such that the horn contact (22) is closed by a depressing of the central section of the covering cap (36) by a particular stroke.

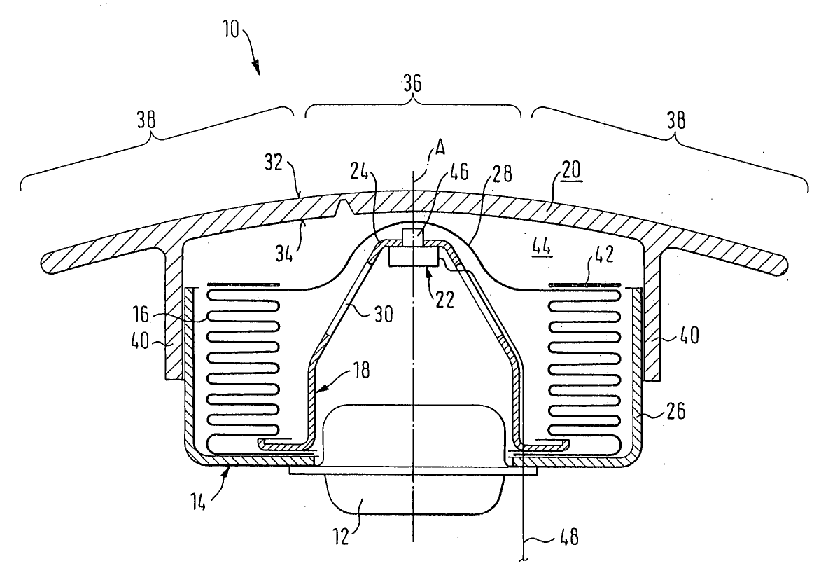

### TECHNICAL FIELD

The invention relates to a vehicle steering wheel having a gas bag module.

### BACKGROUND OF THE INVENTION

In addition to designs in which the entire gas bag module is depressed (floating module) for actuating the horn in a steering wheel with a gas bag module, solutions are also known in which only the covering cap of the gas bag module facing the driver is moved in relation to the stationary components of the gas bag module (floating cover). In accordance with the latter design, the horn contacts are generally arranged on the base of the module or on the rim of the covering cap. A cavity is provided under the central region of the covering cap between the gas bag and the covering cap, so as not to impede the stroke movement of the covering cap. In order to prevent the covering cap from deflecting in the central region when the horn is actuated, it is known to strengthen the covering cap in this region.

However, it has been shown that even reinforced covering caps become very flexible at high temperatures. A “spongy” pressure sensation is thereby produced because the driver has the sensation of pressing into a void owing to the cavity under the covering cap. If the central region of the covering cap deflects to such an extent on actuation that it presses onto the gas bag package lying therebeneath, before the horn contacts are closed, the triggering of the horn is either not possible at all or is only possible with an increased application of force, namely by compressing the gas bag package.

In addition, it is to be taken into account that an increased potential for danger results from reinforced covering caps, if one or more flaps are provided for the gas bag outlet in the reinforced region. Firstly, the hinge region of the flaps must be designed such that the flaps are prevented from being torn off; in fact, owing to the higher mass of the flaps, greater centrifugal forces are in force during opening. Secondly, reinforced flaps can have an unfavourable effect when the driver is situated very close in front of the steering wheel and comes directly in contact with the flaps when they are opened.

It is an object of the invention to make possible a reliable actuation of the horn in a floating cover construction, with a pressure point in the centre of the covering cap, without being confronted with the disadvantages of a reinforced covering cap.

### BRIEF DESCRIPTION OF THE INVENTION

According to the invention, a vehicle steering wheel has a gas bag module. The gas bag module comprises a covering cap and at least one horn contact. The covering cap has a central section and an outer rim section. The horn contact has a contact element arranged between the central section of the covering cap and a stationary component of the gas bag module, such that the horn contact is closed by the central section of the covering cap being depressed by a defined stroke. The invention proceeds from the finding that gas bag module designs are able to be realized in which a stationary component is arranged directly beneath the central section of the covering cap. The arrangement of the contact element on such a component allows to form a horn contact which is closed by depressing the central section of the covering cap by a small, defined stroke. The driver is thereby given a reproducible, unadulterated pressure sensation. It is not necessary to reinforce the covering cap, so no additional costs ensue in the production of the covering cap and the structural space in the module is not restricted.

### BRIEF DESCRIPTION OF THE DRAWINGS

The only FIGURE shows a section through a gas bag module of a steering wheel according to the invention.

### DETAILED DESCRIPTION OF THE PREFERRED EMBODIMENT

The gas bag module 10 illustrated in the FIGURE has a central axis A. The gas bag module (10) comprises a gas generator 12, a generator carrier 14, a gas bag 16, a gas bag retainer plate 18, a covering cap 20 and a horn contact 22. The gas generator 12 is fastened to the generator carrier 14 in a known manner by a generator flange. The inflation opening of the gas bag 16 is clamped between the generator carrier 14 and the gas bag retainer plate 18.

The gas bag retainer plate 18 has a central section which is constructed as a cage 24 (diffusor). The gas bag 16 is housed as a folded gas bag package substantially in the ring-shaped space between the cage 24 and the rim section 26 of the generator carrier 14 which is bent upwards. However, a layer 28 of the gas bag package is guided over the cage 24 and the horn contact 22. The cage 24 has several slit-shaped outflow openings 30 via which the gas bag 16 is inflated, if required, with the gas provided by the gas generator 12.

The covering cap 20 has a front side 32 facing the driver and a rear side 34 facing the interior of the gas bag module 10. The covering cap 20 closes off the gas bag module 10 on the side facing the driver. The covering cap 20 has a central section 36 which lies opposite the cage 24, and an outer rim region 38 with one encircling side wall or several side wall sections 40 running substantially parallel to the rim section 26 of the generator carrier 14. In a known manner, the covering cap 20 has one or more flaps to provide an outlet opening for the gas bag 16, but does not have any special reinforcements. The generator carrier 14 with the parts fastened therein is stationary, whereas the covering cap 20 is displaceable in the direction of the axis A.

The cage 24 of the gas bag module 10 is constructed such that it extends close up to the rear side 34 of the central section 36 of the covering cap 20. The gas bag 16 is fixed in a casing 42 (e.g. made of Tyvek®) such that a defined cavity 44 is formed between the ring-shaped gas bag package and the covering cap 20. A horn contact element 46 which faces the central section 36 of the covering cap 20 is fitted to the central section of the cage 24. The contact element 46 may, for example, be a micro-switch or a contact film. A cable 48 provides the electrical connection of the contact element 46. The cable 48 extends through one of the outflow openings 30 onto the exterior and out of the gas bag module 10 through the gas bag retainer plate 18 and the gas bag 16. The cable 48 is held on the cage 24 by crimp connections. The ground connection of the contact 22 is effected via the sheet metal parts of the gas bag module, in particular the gas bag retainer plate 18.

To actuate the horn, the covering cap 20 is depressed parallel to the axis A towards the interior of the module. After a defined stroke, the central section 36 of the covering cap 20 presses indirectly via the individual gas bag layer 28 onto the contact element 46, such that the horn contact 22 is closed. The fixing of the gas bag 16 by the casing 42 guarantees that the covering cap 20 does not come in contact with the remaining gas bag package during depressing. In order to avoid damage to the gas bag 16 by the contact element 46, a reinforcement can be provided at the corresponding site of the gas bag layer 28.

Alternatively, the contact element 46 can also be arranged on the rear side 34 of the central section 36 of the covering cap 20, such that it is pressed against the central section of the cage 24 during depressing.

In addition, further horn contacts can be provided in a known manner on the rim of the covering cap 20 or on the base of the gas bag module 10.

The cage 24 with its outflow openings 30 is designed such that it serves as an energy-absorbing deformation element in the case of a secondary impact of the driver onto the steering wheel when the gas bag has become slack.

1. A vehicle steering wheel having a gas bag module, the gas bag module comprising a covering cap and at least one horn contact, the covering cap having a central section and an outer rim section, the horn contact having a contact element arranged between the central section of the covering cap and a stationary component of the gas bag module, such that the horn contact is closed by a depressing of the central section of the covering cap by a defined stroke.

2. The vehicle steering wheel according to claim 1, wherein the central section of the covering cap is axially displaceable.

3. The vehicle steering wheel according to claim 1, wherein the contact element comprises a micro-switch.

4. The vehicle steering wheel according to claim 1, wherein the contact element comprises a contact film.

5. The vehicle steering wheel according to claim 1, wherein the contact element is fitted on the stationary component.

6. The vehicle steering wheel according to claim 1, wherein the stationary component is a cage arranged over a gas generator.

7. The vehicle steering wheel according to claim 6, wherein the horn contact is electrically connected via a cable which is held at the outer side of the cage.

8. The vehicle steering wheel according to claim 6, wherein the cage has outflow openings and is designed such that it serves as an energy-absorbing deformation element in the case of an impact of a vehicle occupant onto the steering wheel.

9. The vehicle steering wheel according to claim 1, wherein the contact element is fitted on a rear side of the covering cap.
